(19) United States
(12) Patent Application Publication
(10) Pub. No.: US 2006/0285727 A1
(43) Pub. Date: Dec. 21, 2006

(54) Infrared signature capture device

(75) Inventors: John David Landers JR., Raleigh, NC (US); David John Steiner, Raleigh, NC (US); Kimberly Ann Wood, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/157,542

(22) Filed: Jun. 21, 2005

(51) Int. Cl. G06K 9/00; G09G 5/00

(52) U.S. Cl. 382/119; 345/179

(57) ABSTRACT

A method and system for capturing a written signature is presented. A tip of an infrared transmitting pen transmits an infrared signal to infrared sensors that are aligned along two sides of a rectangular writing surface. As a person's signature is written with the infrared transmitting pen, the sensors capture the written signature.

### BACKGROUND OF THE INVENTION

1. Technical Field

The present invention relates in general to the field of computers, and in particular to computers used to capture hand written signatures. Still more particularly, the present invention relates to an infrared emitting pen whose movements are captured by sensors that are peripheral to a writing surface.

2. Description of the Related Art

At many check-out stations in grocery stores and other retail establishments, customers now sign their name, to authorize a charge or to accept a debit to their account, on a resistive screen. The resistive screen detects pressure from a stylus pen, and translates the movement of the stylus pen into a graphic file that reflects the customer's written signature. A major drawback to such systems, however, is that customers often do not realize that a non-marring stylus pen is to be used, and instead use their personal ink pens against the resistive screen. While the resistive screen will usually still record the customer's signature, repeated scratching on the resistive screen by ink pens leaves the resistive screens scratched up and cloudy, making it difficult to read instructions and/or signature templates that are often laid under the resistive screen.

### SUMMARY OF THE INVENTION

The present invention recognizes the need for a written signature reading device. Thus, the present system discloses an infrared detection system that detects movement of a stylus pen about a signature pad. A tip of the stylus pen includes a low-power infrared signal broadcaster. The low-power infrared signal is detected by infrared sensors located about a perimeter of the signature pad. Each infrared sensor is tuned to sense only infrared signals that are aimed directly at the infrared sensor. As subsequent infrared sensors receive an infrared signal from the stylus pen, a recording of the movement of the stylus pen, and thus the written signature of a user of the stylus pen, is made.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates a first signature pad having infrared transmitters and receivers located about a perimeter of the signature pad, such that a blockage of an infrared transmitter indicates a location of a signal blocking stylus pen;

FIGS. 2a-c depicts a writing capture system that uses infrared receivers located about a perimeter of a writing surface and an active infrared signal transmitting stylus pen;

FIG. 3a illustrates a light channel array in front of each infrared sensor in each of the infrared receivers shown in FIGS. 2a-c;

FIG. 3b depicts a single light channel inside of which is located each infrared sensor in each of the infrared receivers shown in FIGS. 2a-c;

FIG. 4 depicts an exemplary server computer that can be used to control a client computer that uses the writing capture system shown in FIGS. 2a-c;

FIG. 5 illustrates an exemplary client computer controlled by the server computer shown in FIG. 4;

FIG. 6 is a high-level flow-chart of exemplary steps taken by the present invention;

FIGS. 7a-b show a high-level flow chart of steps taken to deploy software capable of executing the steps shown in FIG. 6;

FIGS. 8a-c show a high-level flow chart of steps taken to deploy in a Virtual Private Network (VPN) software that is capable of executing the steps shown in FIG. 6;

FIGS. 9a-b show a high-level flow chart showing steps taken to integrate into an computer system software that is capable of executing the steps shown in FIG. 6; and

FIGS. 10a-b show a high-level flow chart showing steps taken to execute the steps shown in FIG. 6 using an on-demand service provider.

### DETAILED DESCRIPTION OF THE PREFERRED EMBODIMENT

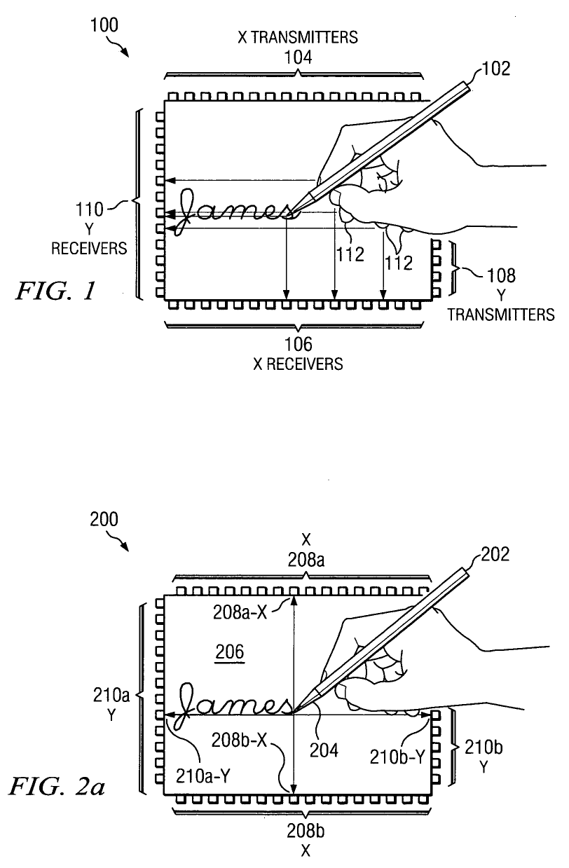

With reference now to the figures, and in particular to FIG. 1, there is depicted an exemplary signature pad 100 that uses a signal blocking stylus pen 102 (which is inert—having no special features other than the ability to block an infrared signal), an array of X-axis infrared transmitters 104 with a corresponding array of X-axis infrared receivers 106, and an array of Y-axis infrared transmitters 108 with their corresponding array of Y-axis infrared receivers 110. As signal blocking stylus pen 102 moves about signature pad 100, signal blocking stylus pen 102 blocks the infrared signals between the infrared transmitters and receivers to create a log of the signal blocking stylus pen 102's movement.

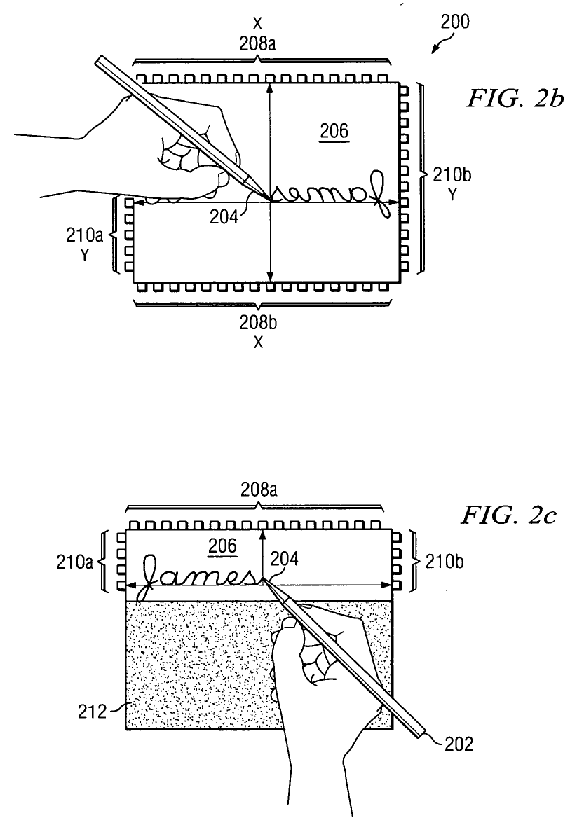

A problem with signature pad 100 is that anything that can block the infrared signals being transmitted can result in a false indicator of stylus movement. For example, a user's fingers 112 lying on signature pad 100 may cause a false blockage signal. To minimize the potential of this problem occurring, a writing capture system 200, shown in FIGS. 2a-c, is presented.

Writing capture system 200 utilizes a signal transmitting pen 202, which has a signal emitting tip 204 that broadcasts a continuous low-power infrared signal across a face of a writing surface 206. As signal transmitting pen 202 (along with signal emitting tip 204) move along the X-axis and Y-axis of writing surface 206, tightly tuned infrared sensors (X-axis movement signal receivers 208a-b and Y-axis movement signal receivers 210a-b) singularly detect the infrared signal being broadcast from signal emitting tip 204.

For example, consider FIG. 2a. At the position shown, signal emitting tip 204 is broadcasting an infrared signal across all of the face of writing surface 206. However, because the infrared signal receivers are tightly tuned and because the infrared signal from signal emitting tip 204 is low-power, only those infrared signal receivers that are directly “facing” signal emitting tip 204 will detect the infrared signal. In FIG. 2a, then, only X-axis movement signal receivers 208a-X and 208b-X and Y-axis movement signal receivers 210a-Y and 210b-Y will detect the infrared signal from signal emitting tip 204. As signal transmitting pen 202 moves to different positions on writing surface 206, different infrared receivers will detect the infrared signal from signal emitting tip 204, thus creating a log of the movement and positions of signal transmitting pen 202 on writing surface 206. If this movement is a written signature, then that written signature can be captured (by logging the sequence that each signal receiver 210 receives an infrared signal from signal transmitting pen 202) and stored for future validation purposes, such as a customer's agreement to certain charges at a check-out station in a retail store.

As shown in FIG. 2b, writing capture system 200 is equally efficient in capturing written signatures from a left-handed writer.

An alternate preferred embodiment is shown in FIG. 2c, in which writing surface 206 is made smaller to avoid the potential of the person, who is signing with the signal transmitting pen 202, accidentally blocking the infrared signal being broadcast by the signal emitting tip 204. To further minimize this potential for error, an elevated wrist support pad 212 may be provided, thus causing signal transmitting pen 202 to be naturally aligned in a more “upright” position (more perpendicular to writing surface 206).

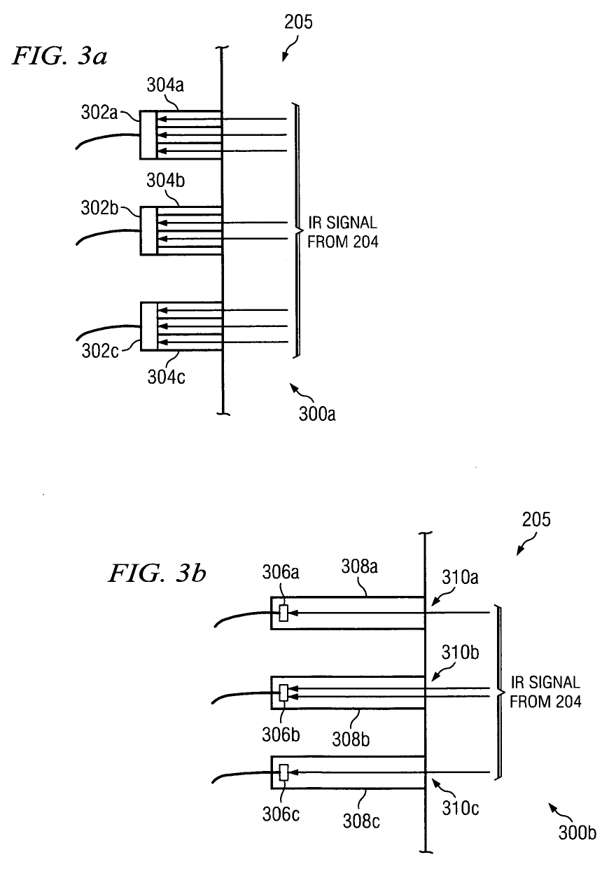

There are several ways to tune the infrared receivers such that only “direct” infrared signals are detected. For example, FIG. 3a shows an exemplary infrared tuning system 300a, in which infrared sensors 302 each have an attached light channel array 304. Light channel arrays 304 are preferably made of infrared-absorbing material. Thus, an infrared (IR) signal from signal emitting tip 204 is able to reach IR sensor 302b. However, because the IR signal is slightly offset to (not aimed directly at) IR sensors 302a and 302c, their respective attached light channel arrays 304a and 304c absorb the incoming IR signal, thus preventing IR sensors 302a and 302c from sensing the IR signal from signal emitting tip 204.

Another preferred system for tuning the IR sensors is shown in FIG. 3b as IR tuning system 300b, which uses single light channels 308 for each IR sensor 306. As shown, the single light channels 308 are much deeper than the light channel arrays 304 shown in FIG. 3a. Nonetheless, the operational concept for IR tuning system 300b is similar to that of IR tuning system 300a. The IR light (signal) from signal emitting tip 204 is absorbed by the interior of the single light channels 308 unless the IR signal is directly shined at the IR sensor 306. Thus, in FIG. 3b, IR sensor 306b senses the IR signal and thus location of signal emitting tip 204, while IR sensors 306a and 306c do not detect this IR signal.

Using the IR tuning system 300a or 300b shown in respective FIGS. 3a and 3b, the writing capture system 200 shown in FIGS. 2a-c need to have only two adjacent sides of the periphery of writing surface 206 lines with IR sensors. For example, X-axis movement signal receivers 208a and Y-axis movement signal receivers 210a are adequate for detecting any movement of signal transmitting pen 202. While X-axis movement signal receivers 208b and Y-axis movement signal receivers 210b may be retained as back-up or check sensors (to confirm signals received by X-axis movement signal receivers 208a and Y-axis movement signal receivers 210a or to overcome inadvertent interference), X-axis movement signal receivers 208b and Y-axis movement signal receivers 210b are not necessary for writing capture system 200 to operate properly.

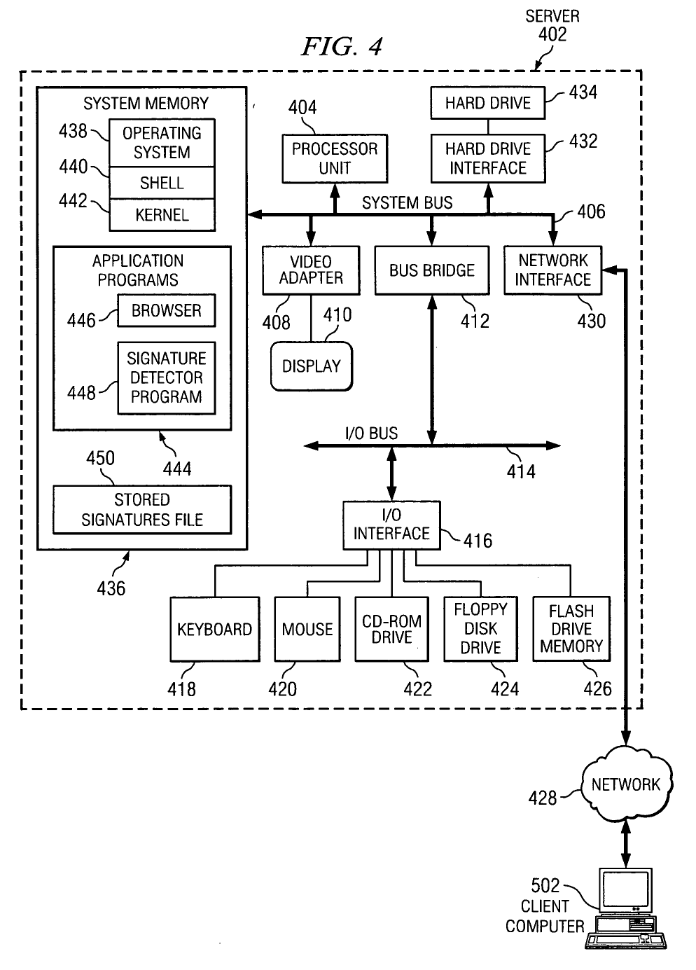

With reference now to FIG. 4, there is depicted a block diagram of an exemplary server 402 that can be used to deploy software described below. Server 402 includes a processor unit 404 coupled to a system bus 406. Also coupled to system bus 406 is a video adapter 408, which drives/supports a display 410. System bus 406 is coupled via a bus bridge 412 to an Input/Output (I/O) bus 414. Coupled to I/O bus 414 is an I/O interface 416, which affords communication with various I/O devices, including a keyboard 418, a mouse 420, a Compact Disk-Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Server 402 is able to communicate with a client computer 502 via a network 428 using a network interface 430, which is coupled to system bus 406. Preferably, network 428 is the Internet.

Also coupled to system bus 406 is a hard drive interface 432, which interfaces with a hard drive 434. In a preferred embodiment, hard drive 434 populates a system memory 436, which is also coupled to system bus 406. Data that populates system memory 436 includes server 402's operating system 438, which includes a command interpreter program known as a shell 440, which is incorporated in a higher level operating system layer and utilized for providing transparent user access to resources such as application programs 444, which include a browser 446, a signature detector program 448, as well as data files including but not limited to a stored signatures file 450.

As is well known in the art, a command interpreter or “shell” is generally a program that provides an interpreter and interfaces between the user and the operating system. More specifically, a shell program executes commands that are entered into a command line user interface or from a file.

The shell (UNIX) or command processor (Windows) is generally the highest level of the operating system software hierarchy and serves as a command interpreter. The shell typically provides a system prompt, interprets commands entered by keyboard, mouse, or other user input media, and sends the interpreted command(s) to the appropriate lower levels of the operating system (e.g. a kernel 442) for processing.

Exemplary application programs 444 used in the present invention are web browser 446 and signature detector program 448. Web browser 446 includes program modules and instructions enabling a World Wide Web (WWW) client (i.e., client computer 502) to send and receive network messages to the Internet using HyperText Transfer Protocol (HTTP) messaging.

Signature detector program 448 tracks and records when each IR sensor aligned around the writing surface 206 (shown in FIGS. 2a-c) detects an IR signal from the signal emitting tip 204. By tracking and recording these distinct IR detection events, a complete record of the movement of the signal transmitting pen 202 is recorded, including a user's written signature. These signatures are converted into stored signature files 450, which associate the recorded written signature with a particularly identified customer (signatory), which can be used to confirm that the customer agreed to terms of a transaction at a check-out station in a retail store.

The hardware elements depicted in server 402 are not intended to be exhaustive, but rather are representative to highlight essential components required by the present invention. For instance, server 402 may include alternate memory storage devices such as magnetic cassettes, Digital Versatile Disks (DVDs), Bernoulli cartridges, and the like. These and other variations are intended to be within the spirit and scope of the present invention.

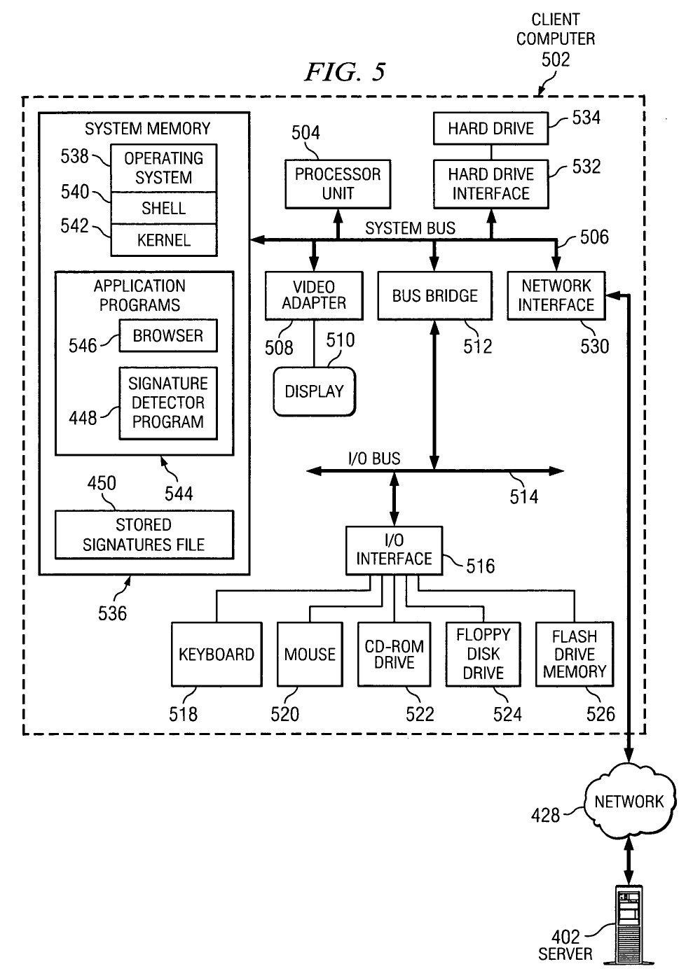

With reference now to FIG. 5, there is depicted a block diagram of an exemplary client computer 502, which is an exemplary computer used at a check-out station in a retail store. Client computer 502 includes a processor unit 504 coupled to a system bus 506. Also coupled to system bus 506 is a video adapter 508, which drives/supports a display 510. System bus 506 is coupled via a bus bridge 512 to an Input/Output (I/O) bus 514. Coupled to I/O bus 514 is an I/O interface 516, which affords communication with various I/O devices, including a keyboard 518, a mouse 520, a Compact Disk-Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Client computer 502 is able to communicate with server 402 via network 428 using a network interface 530, which is coupled to system bus 406.

Also coupled to system bus 506 is a hard drive interface 532, which interfaces with a hard drive 534. In a preferred embodiment, hard drive 534 populates a system memory 536, which is also coupled to system bus 506. Data that populates system memory 536 includes client computer 502's operating system 538, which includes a shell 540 and a kernel 542, for providing transparent user access to resources such as application programs 544, which include a browser 546. Note that client computer 502 can also hold a copy of the signature detector program 448 and stored signatures file 450 for autonomous operation of the system and method described herein.

The hardware elements depicted in client computer 502 are not intended to be exhaustive, but rather are representative to highlight essential components required by the present invention. For instance, client computer 502 may include alternate memory storage devices such as magnetic cassettes, Digital Versatile Disks (DVDs), Bernoulli cartridges, and the like. These and other variations are intended to be within the spirit and scope of the present invention.

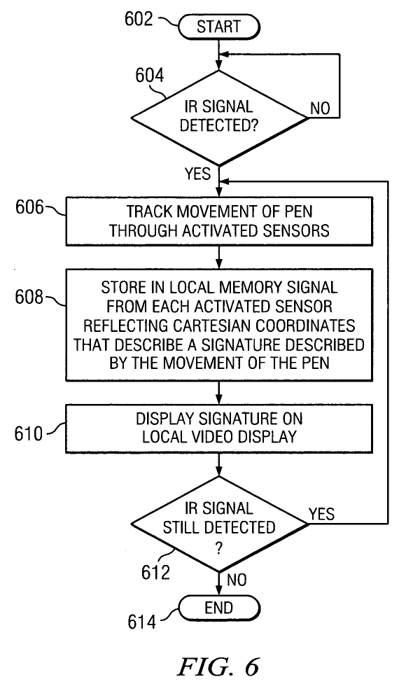

Referring now to FIG. 6, a high-level flow chart of preferred steps taken by the present invention is presented. After initiator block 602, a query (query block 604) is made as to whether an IR signal is detected by any of the IR sensors discussed above. Since the IR sensors are tuned, they should not receive any stray IR signals from ambient sources such as PDAs, tablet computers, conventional light sources, the sun, etc.

Movement of the IR signal transmitting pen is tracked (block 606). This movement is stored in local memory (such as in a local system memory, cache or buffer) as a movement data that reflects Cartesian-like coordinates describing the movement of the pen (block 608). Alternatively, this movement data can be stored, either locally in a client computer or remotely in a server operated by a same enterprise or by a third party service provider, in a permanent signature data file.

The detected signature can optionally be displayed on a local video display at a check-out station (block 610) while the pen is moving about the writing surface. When the IR signal transmitting pen is lifted away from the writing surface, then the IR sensors no longer detect any IR signal (query block 612), and the process ends.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

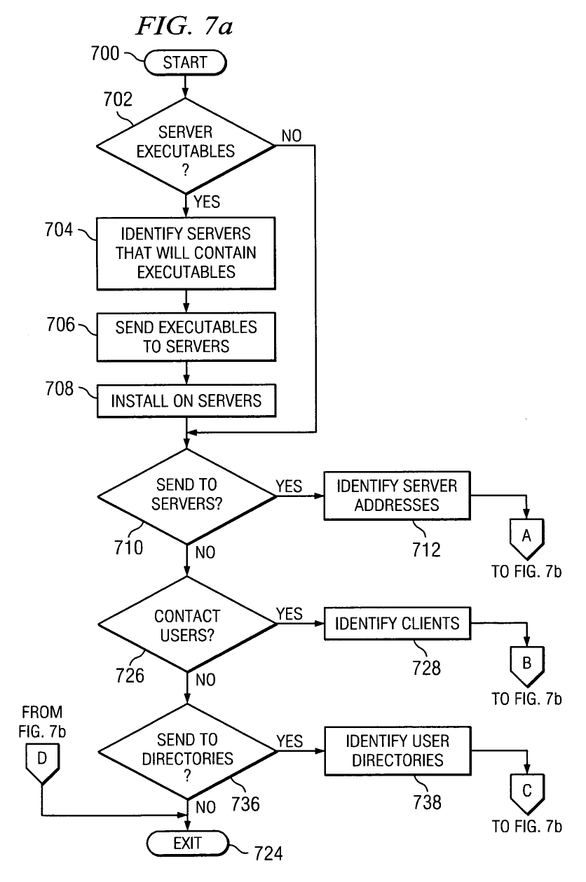

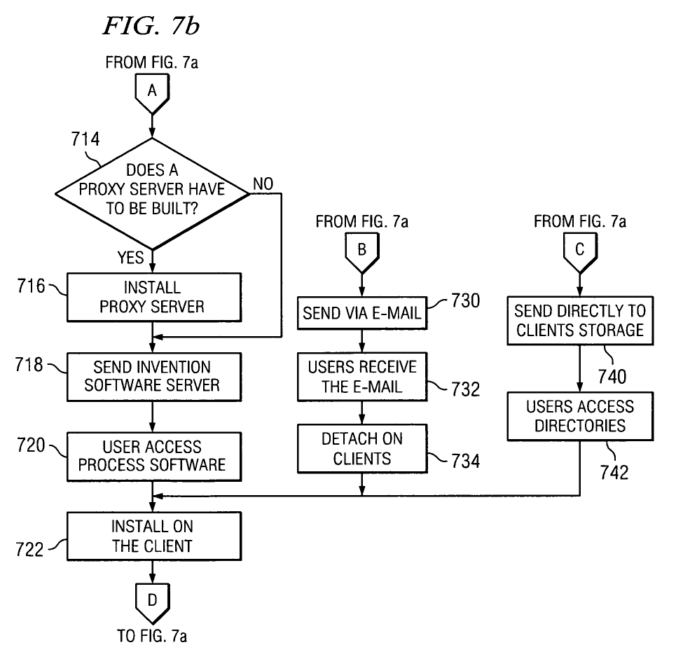

Thus, the method described in FIG. 6 can be deployed as a process software. Referring now to FIGS. 7a-b, step 700 begins the deployment of the process software. The first thing is to determine if there are any programs that will reside on a server or servers when the process software is executed (query block 702). If this is the case, then the servers that will contain the executables are identified (block 704). The process software for the server or servers is transferred directly to the servers' storage via File Transfer Protocol (FTP) or some other protocol or by copying though the use of a shared file system (block 706). The process software is then installed on the servers (block 708).

Next, a determination is made on whether the process software is be deployed by having users access the process software on a server or servers (query block 710). If the users are to access the process software on servers, then the server addresses that will store the process software are identified (block 712).

A determination is made if a proxy server is to be built (query block 714) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 716). The process software is sent to the servers either via a protocol such as FTP or it is copied directly from the source files to the server files via file sharing (block 718). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 720). Another embodiment is to have the servers automatically copy the process software to each client and then run the installation program for the process software at each client computer. The user executes the program that installs the process software on his client computer (block 722) then exits the process (terminator block 724).

In query step 726, a determination is made whether the process software is to be deployed by sending the process software to users via e-mail. The set of users where the process software will be deployed are identified together with the addresses of the user client computers (block 728). The process software is sent via e-mail to each of the users' client computers (block 730). The users then receive the e-mail (block 732) and then detach the process software from the e-mail to a directory on their client computers (block 734). The user executes the program that installs the process software on his client computer (block 722) then exits the process (terminator block 724).

Lastly a determination is made on whether to the process software will be sent directly to user directories on their client computers (query block 736). If so, the user directories are identified (block 738). The process software is transferred directly to the user's client computer directory (block 740). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 742). The user executes the program that installs the process software on his client computer (block 722) and then exits the process (terminator block 724).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called tunnel interfaces, where the packet enters and exits the network.

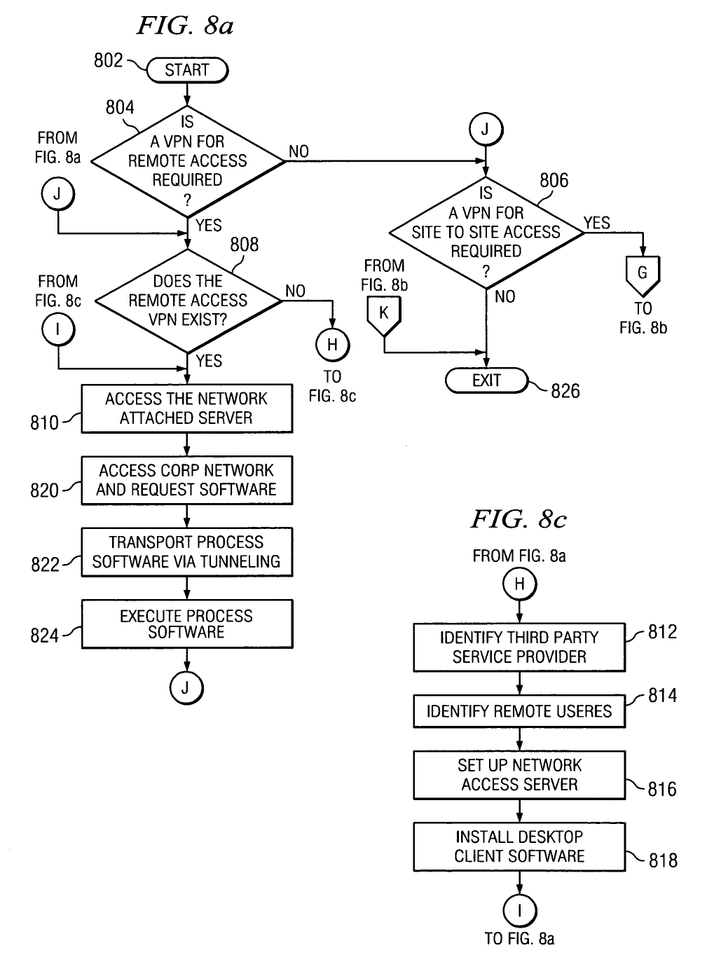

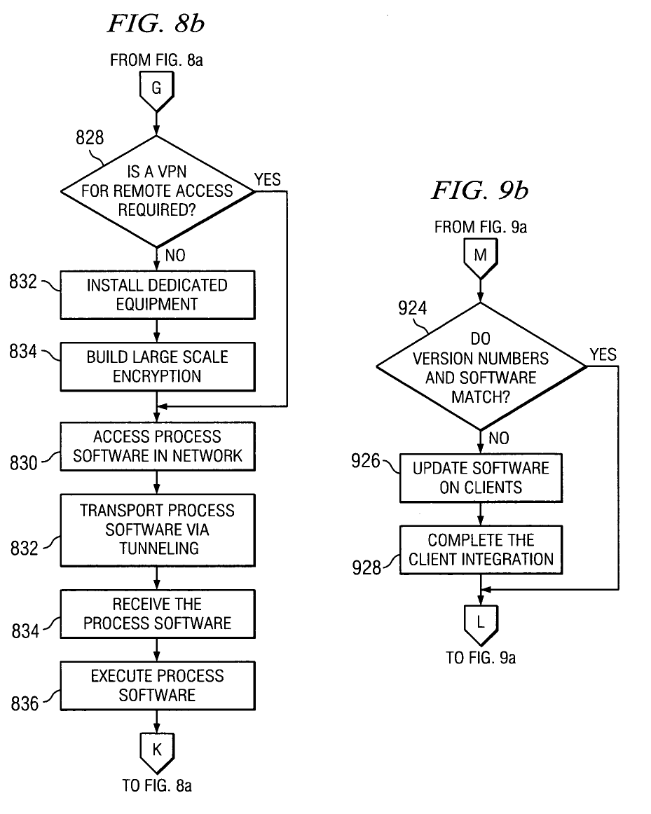

The process for such VPN deployment is described in FIGS. 8a-c. Initiator block 802 begins the Virtual Private Network (VPN) process. A determination is made to see if a VPN for remote access is required (query block 804). If it is not required, then proceed to (query block 806). If it is required, then determine if the remote access VPN exists (query block 808).

If a VPN does exist, then proceed to block 810. Otherwise identify a third party provider that will provide the secure, encrypted connections between the company's private network and the company's remote users (block 812). The company's remote users are identified (block 814). The third party provider then sets up a network access server (NAS) (block 816) that allows the remote users to dial a toll free number or attach directly via a broadband modem to access, download and install the desktop client software for the remote-access VPN (block 818).

After the remote access VPN has been built or if it been previously installed, the remote users can access the process software by dialing into the NAS or attaching directly via a cable or DSL modem into the NAS (block 810). This allows entry into the corporate network where the process software is accessed (block 820). The process software is transported to the remote user's desktop over the network via tunneling. That is the process software is divided into packets and each packet including the data and protocol is placed within another packet (block 822). When the process software arrives at the remote user's desktop, it is removed from the packets, reconstituted and then is executed on the remote users desktop (block 824).

A determination is then made to see if a VPN for site to site access is required (query block 806). If it is not required, then proceed to exit the process (terminator block 826). Otherwise, determine if the site to site VPN exists (query block 828). If it does exist, then proceed to block 830. Otherwise, install the dedicated equipment required to establish a site to site VPN (block 832). Then build the large scale encryption into the VPN (block 834).

After the site to site VPN has been built or if it had been previously established, the users access the process software via the VPN (block 830). The process software is transported to the site users over the network via tunneling (block 832). That is the process software is divided into packets and each packet including the data and protocol is placed within another packet (block 834). When the process software arrives at the remote user's desktop, it is removed from the packets, reconstituted and is executed on the site users desktop (block 836). The process then ends at terminator block 826.

Software Integration

The process software which consists code for implementing the process described in FIG. 6 may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

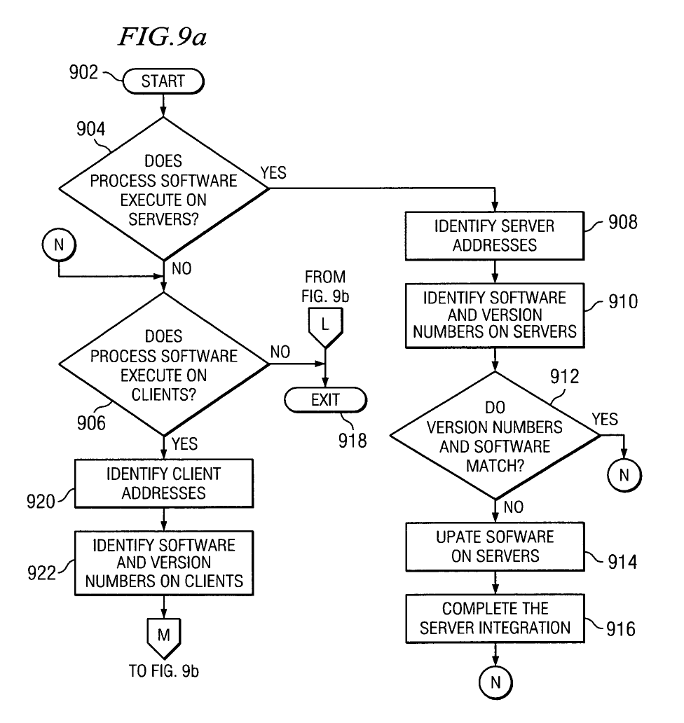

For a high-level description of this process, reference is now made to FIGS. 9a-b. Initiator block 902 begins the integration of the process software. The first thing is to determine if there are any process software programs that will execute on a server or servers (block 904). If this is not the case, then integration proceeds to query block 906. If this is the case, then the server addresses are identified (block 908). The servers are checked to see if they contain software that includes the operating system (OS), applications, and network operating systems (NOS), together with their version numbers, which have been tested with the process software (block 910). The servers are also checked to determine if there is any missing software that is required by the process software in block 910.

A determination is made if the version numbers match the version numbers of OS, applications and NOS that have been tested with the process software (block 912). If all of the versions match and there is no missing required software the integration continues in query block 906.

If one or more of the version numbers do not match, then the unmatched versions are updated on the server or servers with the correct versions (block 914). Additionally if there is missing required software, then it is updated on the server or servers in the step shown in block 914. The server integration is completed by installing the process software (block 916).

The step shown in query block 906, which follows either the steps shown in block 904, 912 or 916 determines if there are any programs of the process software that will execute on the clients. If no process software programs execute on the clients the integration proceeds to terminator block 918 and exits. If this not the case, then the client addresses are identified as shown in block 920.

The clients are checked to see if they contain software that includes the operating system (OS), applications, and network operating systems (NOS), together with their version numbers, which have been tested with the process software (block 922). The clients are also checked to determine if there is any missing software that is required by the process software in the step described by block 922.

A determination is made is the version numbers match the version numbers of OS, applications and NOS that have been tested with the process software (query block 924). If all of the versions match and there is no missing required software, then the integration proceeds to terminator block 918 and exits.

If one or more of the version numbers do not match, then the unmatched versions are updated on the clients with the correct versions (block 926). In addition, if there is missing required software then it is updated on the clients (also block 926). The client integration is completed by installing the process software on the clients (block 928). The integration proceeds to terminator block 918 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

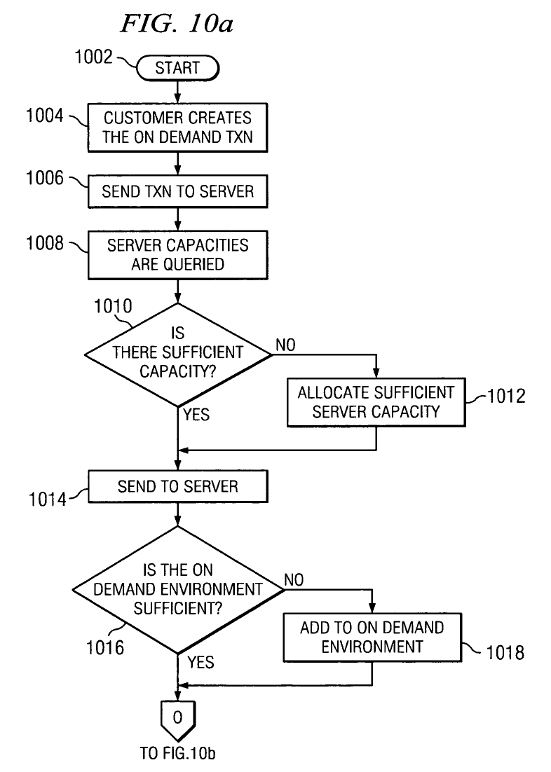

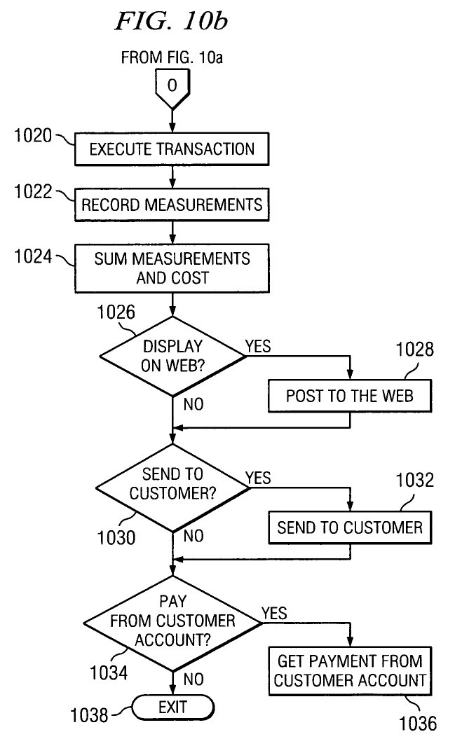

With reference now to FIG. 10a-b, initiator block 1002 begins the On Demand process. A transaction is created than contains the unique customer identification, the requested service type and any service parameters that further specify the type of service (block 1004). The transaction is then sent to the main server (block 1006). In an On Demand environment the main server can initially be the only server, then as capacity is consumed other servers are added to the On Demand environment.

The server central processing unit (CPU) capacities in the On Demand environment are queried (block 1008). The CPU requirement of the transaction is estimated, then the servers available CPU capacity in the On Demand environment are compared to the transaction CPU requirement to see if there is sufficient CPU available capacity in any server to process the transaction (query block 1010). If there is not sufficient server CPU available capacity, then additional server CPU capacity is allocated to process the transaction (block 1012). If there was already sufficient Available CPU capacity then the transaction is sent to a selected server (block 1014).

Before executing the transaction, a check is made of the remaining On Demand environment to determine if the environment has sufficient available capacity for processing the transaction. This environment capacity consists of such things as but not limited to network bandwidth, processor memory, storage etc. (block 1016). If there is not sufficient available capacity, then capacity will be added to the On Demand environment (block 1018). Next the required software to process the transaction is accessed, loaded into memory, then the transaction is executed (block 1020).

The usage measurements are recorded (block 1022). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1024).

If the customer has requested that the On Demand costs be posted to a web site (query block 1026), then they are posted (block 1028). If the customer has requested that the On Demand costs be sent via e-mail to a customer address (query block 1030), then these costs are sent to the customer (block 1032). If the customer has requested that the On Demand costs be paid directly from a customer account (query block 1034), then payment is received directly from the customer account (block 1036). The On Demand process is then exited at terminator block 1038.

The present invention thus provides an improved method, system and service for recording a signature. Note, however, that the process described can be used to capture any written subject matter, including graphical figures, numbers, letters, etc. Furthermore, while the invention has been described in exemplary manner as being used at a check-out station in a retail store, it may also be used in any situation in which a hand written image is to desired to be captured, including signature pads for delivery services, hand-held devices used by personnel such as, but not limited to, meter readers, etc.

While the invention has been particularly shown and described with reference to a preferred embodiment, it will be understood by those skilled in the art that various changes in form and detail may be made therein without departing from the spirit and scope of the invention. For example, while writing capture system 200 has been described only as capturing a signature as described, writing capture system 200 can capture any written image. Furthermore, in an alternate preferred embodiment, writing surface 206 is an infrared and/or pressure touch display, allowing a touch input to enact operation of an active window, button, etc. on the touch display, thus providing a dual-functionality of both a writing capture device and a button-activating device.

What is claimed is:

1. A system comprising:
a plurality of sensors oriented on a periphery of a writing surface, each of the plurality of sensors being tuned to sense a signal only from a limited arc field of view;
a signal transmitting pen; and
a pen movement interpreter, wherein the sensors detect a movement of the signal transmitting pen across the writing surface, and wherein the pen movement interpreter stores the detected movement of the signal transmitting pen.

2. The system of claim 1, wherein the signal transmitting pen transmits an infrared signal, and wherein the plurality of sensors are infrared sensors.

3. The system of claim 2, further comprising:
a plurality of physical signal channels, wherein each of the physical signal channels has an open end oriented towards the writing surface, and wherein each of the plurality of sensors is oriented within a separate one of the plurality of physical signal channels, such that a first infrared sensor in a first physical signal channel is tuned to sense the infrared signal from the signal transmitting pen when the second and third infrared sensors, which are oriented within respective second and third physical signal channels, are unable to sense the infrared signal from the signal transmitting pen.

4. The system of claim 3, further comprising:
a hand rest area outside the periphery of the writing surface, wherein a user's hand does not interfere with an infrared signal between the signal transmitting pen and the infrared sensors.

5. The system of claim 3, wherein the pen movement interpreter captures a person's signature created by the movement of the signal transmitting pen.

6. The system of claim 3, further comprising:
a display for displaying a movement of the signal transmitting pen, wherein the movement is converted into a movement data and stored in a temporary storage area by the pen movement interpreter, and wherein the stored movement data is converted into a visual display for viewing on the display.

7. The system of claim 2, wherein each infrared sensor is tuned to sense an infrared signal from the signal transmitting pen only if the infrared signal is normal to a front surface of the infrared sensor.

8. The system of claim 7, wherein the front surface of the infrared sensor includes an array of light channels that prevent incoming infrared light from striking an infrared detector in the infrared sensor unless the incoming infrared light is perpendicular to the front surface of the infrared sensor.

9. The system of claim 2, wherein the periphery of the writing surface is a rectangle, and wherein only two adjacent sides of the periphery contain the infrared sensors.

10. A method comprising:
detecting a movement of a signal transmitting pen, wherein the signal transmitting pen continually transmits a signal, and wherein the movement of the signal transmitting pen is detected by a plurality of sensors oriented about a writing surface.

11. The method of claim 10, wherein the signal transmitting pen transmits an infrared signal, and wherein the plurality of sensors are infrared sensors.

12. The method of claim 11, further comprising:
capturing a person's signature that is created by the movement of the signal transmitting pen, wherein the person's signature is represented by a signature data temporarily stored by a pen movement interpreter.

13. The method of claim 12, further comprising:
generating a representation of the person's signature on a display using the signature data.

14. The method of claim 12, further comprising:
storing the signature data in a remote location.

15. A machine-readable medium having a plurality of instructions processable by a machine embodied therein, wherein said plurality of instructions, when processed by said machine causes said machine to perform a method comprising:
detecting a movement of a signal transmitting pen, wherein the signal transmitting pen continually transmits a signal, and wherein the movement of the signal transmitting pen is detected by a plurality of sensors oriented about a writing surface.

16. The machine-readable medium of claim 15, wherein the signal transmitting pen transmits an infrared signal, and wherein the plurality of sensors are infrared sensors.

17. The machine-readable medium of claim 16, wherein the method further comprises:
capturing a person's signature that is created by the movement of the signal transmitting pen, wherein the person's signature is represented by a signature data temporarily stored by a pen movement interpreter.

18. The machine-readable medium of claim 17, wherein the method further comprises:
generating a representation of the person's signature on a display using the signature data.

19. The machine-readable medium of claim 15, wherein the processable instructions are deployed to a server from a remote location.

20. The machine-readable medium of claim 15, wherein the processable instructions are provided by a service provider to a customer on an on-demand basis.
